(19) United States
(12) Patent Application Publication
(10) Pub. No.: US 2025/0133583 A1
(43) Pub. Date: Apr. 24, 2025

(54) SIDELINK TRANSMISSION AND RECEPTION

(71) Applicant: NEC Corporation, Tokyo (CN)

(72) Inventors: Gang WANG, Beijing (CN); Zhaobang MIAO, Beijing (CN)

(73) Assignee: NEC Corporation, Tokyo (CN)

(21) Appl. No.: 18/989,878

(22) Filed: Dec. 20, 2024

Related U.S. Application Data
(62) Division of application No. 17/441,352, filed on Sep. 21, 2021.

(51) Int. Cl. H04W 72/51; H04L 27/26; H04W 56/00; H04W 72/02; H04W 72/20

(52) U.S. Cl. CPC H04W 72/51; H04L 27/26025; H04L 27/2607; H04W 56/001; H04W 72/02; H04W 72/20

(57) ABSTRACT

Embodiments of the present disclosure relate to methods, devices and computer readable media for sidelink transmission and reception. A method of communication comprises receiving, at a receiving device, information from a transmitting device in a first slot starting from a first time. The method further comprises, in response to additional reception of the information being enabled, receiving the information from the transmitting device in a second slot starting from a second time, the second time being later than the first time by a time interval. Embodiments of the present disclosure can fulfill the coverage requirement for V2X communications in NR.

### CROSS REFERENCE TO RELATED APPLICATIONS

This application is a is a Divisional Application of U.S. application Ser. No. 17/441,352, filed on Sep. 21, 2021, which is a National Stage of International Application No. PCT/CN2019/079863 filed on Mar. 27, 2019.

### TECHNICAL FIELD

Embodiments of the present disclosure generally relate to the field of telecommunication, and in particular, to methods, devices and computer storage media for sidelink transmission and reception.

### BACKGROUND

Vehicle to everything (V2X) communications are enabled in 5G New Radio (NR). According to the latest 3GPP specifications, NR V2X needs to support the coverage of more than 1000 meters. That is, if a terminal device directly uses the timing derived from a synchronization signal to receive information from another terminal device, a timing difference between reception of the synchronization signal and reception of the information may be up to 6.66 μs.

Typically, a Cyclic Prefix (CP) can be used to accommodate such timing difference on a sidelink (that is, a link between two different terminal devices). However, CP lengths supported in 5G NR are all shorter than 6.66 μs. That is, with the CP lengths supported in 5G NR, the above coverage requirement cannot be fulfilled.

### SUMMARY

In general, example embodiments of the present disclosure provide methods, devices and computer storage media for sidelink transmission and reception.

In a first aspect, there is provided a method of communication. The method comprises: receiving, at a receiving device, information from a transmitting device in a first slot starting from a first time; and in response to additional reception of the information being enabled, receiving the information from the transmitting device in a second slot starting from a second time, the second time being later than the first time by a time interval.

In a second aspect, there is provided a method of communication. The method comprises: obtaining, at a transmitting device, information to be transmitted to a receiving device; in response to first transmission of the information being enabled, transmitting the information to the receiving device in a first slot starting from a first time; and in response to second transmission of the information being enabled, transmitting the information to the receiving device in a second slot starting from a second time, the second time being later than the first time by a time interval.

In a third aspect, there is provided a receiving device. The receiving device comprises a processor and a memory coupled to the processor. The memory stores instructions that when executed by the processor, cause the receiving device to perform the method according to the first aspect of the present disclosure.

In a fourth aspect, there is provided a transmitting device. The transmitting device comprises a processor and a memory coupled to the processor. The memory stores instructions that when executed by the processor, cause the transmitting device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram showing an example of sidelink reception in accordance with some embodiments of the present disclosure;

FIG. 3 illustrates an example method of sidelink reception in accordance with some embodiments of the present disclosure;

FIG. 4 illustrates a schematic diagram showing an example of sidelink transmission in accordance with some embodiments of the present disclosure;

FIG. 5 illustrates an example method of sidelink transmission in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, a user equipment (UE), a mobile phone, a computer, a personal digital assistant, a game machine, a wearable device, an on-vehicle communication device, a machine type communication (MTC) device, a device to device (D2D) communication device, a vehicle to everything (V2X) communication device, a sensor and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As described above, according to the latest 3GPP specifications, NR V2X needs to support the coverage of more than 1000 meters. That is, if a terminal device directly uses the timing derived from a synchronization signal to receive information from another terminal device, a timing difference between reception of the synchronization signal and reception of the information may be up to 6.66 μs.

Typically, a Cyclic Prefix (CP) can be used to accommodate such timing difference on a sidelink (that is, a link between two different terminal devices). For example, Table 1 shows various CP lengths supported in NR.

TABLE 1
CP lengths supported in NR

| Subcarrier | Normal CP | Extended CP |
|---|---|---|
| Spacing (kHz) | length (μs) | length (μs) |
| 15 | 4.69 | — |
| 30 | 2.34 | — |
| 60 | 1.17 | 4.17 |
| 120 | 0.586 | — |

It can be seen that, the CP lengths supported in NR are all shorter than 6.66 μs. That is, with the CP lengths supported in NR, the coverage requirement for NR V2X communications cannot be met.

Some traditional schemes allow a terminal device to use a network device (such as, a base station) as a synchronization source and accommodate the above timing difference by calculating a propagation delay based on a distance between the terminal device and the network device. However, these schemes are only applicable to terminal devices that are within the coverage of the network device. Moreover, in some cases, the propagation delay calculated based on the distance may not be accurate. Some other traditional schemes support multiple geographical zones, each associated with a dedicated resource set and independent timing. However, these schemes may bring down the resource efficiency due to the large number of configured resource sets.

Embodiments of the present disclosure provide a solution for sidelink transmission and reception, so as to solve the above problems and one or more of other potential problems. This solution can fulfill the coverage requirement for V2X communications in NR. Principles and implementations of the present disclosure will be described in detail below with reference to the figures.

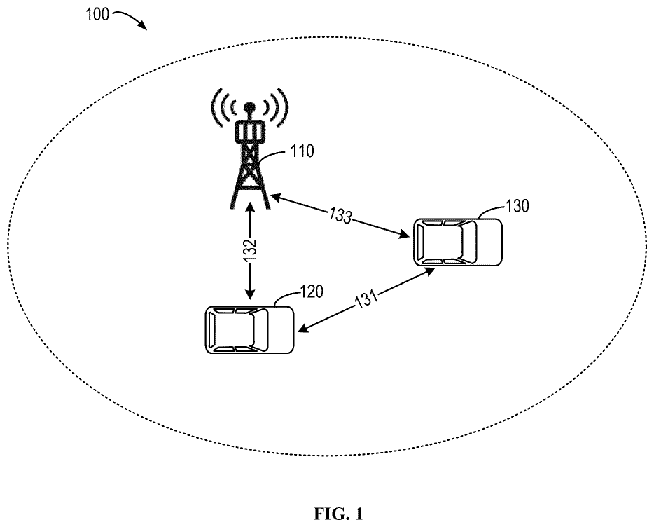

FIG. 1 illustrates a schematic diagram of an example communication system 100 in which embodiments of the present disclosure can be implemented. As shown in FIG. 1, the communication system 100 may include a synchronization source 110 and terminal devices 120 and 130. It is to be understood that the number of devices in FIG. 1 is given for the purpose of illustration without suggesting any limitations to the present disclosure. The communication network 100 may include any suitable number of synchronization sources and/or terminal devices adapted for implementing implementations of the present disclosure.

In some embodiments, the synchronization source 110 may be a network device serving the terminal devices 120 and 130. Alternatively, in some embodiments, the synchronization source 110 may be another terminal device. As shown in FIG. 1, the synchronization source 110 may communicate with the terminal devices 120 and 130 via channels (such as, wireless communication channels) 132 and 133, respectively. For example, the synchronization source 110 may transmit synchronization signals to the terminal devices 120 and 130 via the channels 132 and 133, respectively. The terminal devices 120 and 130 may determine timing for transmitting and/or receiving information based on the received synchronization signals. In the following, some embodiments will be described with reference to a network device as an example of the synchronization source 110. It is to be understood that this is merely for the purpose of discussion, without suggesting any limitations to the scope of the present disclosure.

The terminal devices 120 and 130 are shown in FIG. 1 as vehicles which enable D2D communications (such as, V2X communications). It is to be understood that embodiments of the present disclosure are also applicable to other terminal devices than vehicles, such as mobile phones, sensors and so on. In some embodiments, the terminal device 120 may communicate with the terminal device 130 via a D2D communication link 131. As used herein, the D2D communication link 131 may also be referred to as a sidelink. In some embodiments, the sidelink may be half-duplex or full-duplex. For example, the terminal device 120 can transmit information to the terminal device 130 via the sidelink 131. The terminal device 130 can likewise transmit information to the terminal device 120 via the sidelink 131.

In the transmission from the terminal device 120 to the terminal device 130 via the sidelink 131, the terminal device 120 may act as a transmitting device, while the terminal device 130 acting as a receiving device. In the transmission from the terminal device 130 to the terminal device 120 via the sidelink 131, the terminal device 130 may act as a transmitting device, while the terminal device 120 may act as a receiving device. In the following, some embodiments will be described with reference to the terminal device 130 as an example of a transmitting device and with reference to the terminal device 120 as an example of a receiving device. For example, the terminal device 120 may also be referred to as the “receiving device 120”, and the terminal device 130 may also be referred to as the “transmitting device 130”. It is to be understood that this is merely for the purpose of discussion, without suggesting any limitations to the scope of the present disclosure.

The communications in the communication system 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

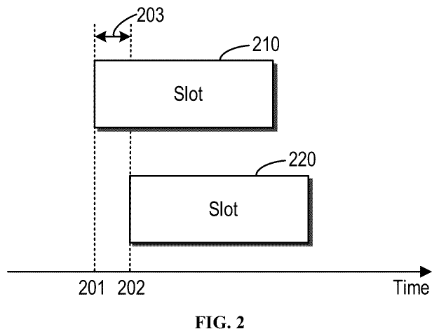

FIG. 2 illustrates a schematic diagram showing an example of sidelink reception in accordance with some embodiments of the present disclosure.

As shown in FIG. 2, in some embodiments, for sidelink communications, if a receiving device (for example, the terminal device 120 in FIG. 1) is configured to receive information (such as, Physical Sidelink Control Channel (PSCCH) and/or Physical Sidelink Shared Channel (PSSCH)) from a transmitting device (for example, the terminal device 130 in FIG. 1) in a slot 210 starting from a time 201, the receiving device may also need to receive the information in at least one additional slot 220 starting from another time 202. The time 202 may be later than the time 201 by a time interval 203. For example, the time interval 203 may be a threshold time interval which is specified, preconfigured or configured to the receiving device.

In some embodiments, the slot 210 may be included in a set of resources configured for reception of the information from the transmitting device 130. For example, the index of the slot 210 and the starting time 201 of the slot 210 may be determined based a synchronization signal received from the synchronization source 110. In some embodiments, the slot 220 may be included in another set of resources configured for reception of the information form the transmitting device 130, and the slot 220 starting from the time 202 may be determined based on the slot 210 and the time interval 203. In this way, the timing difference (for example, up to 6.66 μs as described above) between the reception of the synchronization signal and the reception of the information can be accommodated, thereby ensuring the coverage requirement for NR V2X to be satisfied.

Alternatively, in some embodiments, for sidelink communications, the transmitting device may adjust the timing for the transmission of the information based on a timing advance value (for example, which may be determined by the transmitting device or indicated by one or more receiving devices). In this case, the additional reception of the information in the slot 220 may be disabled. That is, the receiving device may only receive the information in the slot 210, without receiving the information in the slot 220.

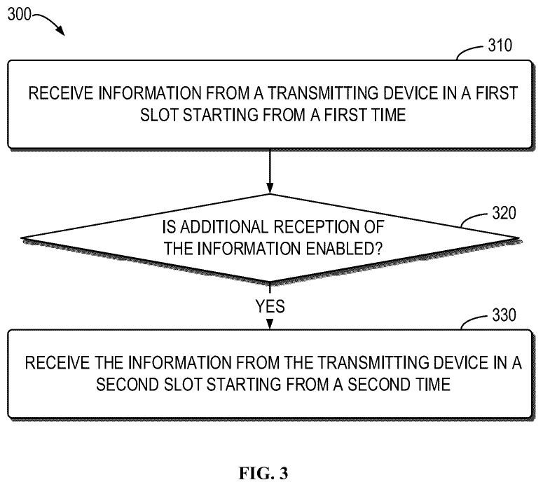

More details about sidelink reception will be described with reference to FIG. 3, which illustrates an example method 300 of sidelink reception in accordance with some embodiments of the present disclosure. For example, the method 300 may be performed at a communication device which acts as a receiving device, such as the terminal device 120. For the purpose of discussion, in the following, the method 300 will be described with reference to FIG. 2. It is to be understood that the method 300 may include additional blocks not shown and/or may omit some blocks as shown, and the scope of the present disclosure is not limited in this regard.

At block 310, the terminal device 120 receives information from a transmitting device (for example, the terminal device 130) in the slot 210 starting from the time 201.

In some embodiments, prior to receiving the information from the transmitting device, the terminal device 120 may determine the timing for receiving the information. In some embodiments, the terminal device 120 may receive a synchronization signal from the synchronization source 110 and determine the timing for receiving the information based on the received synchronization signal. For example, the terminal device 120 may determine an index of the slot 210 as well as the starting time 201 of the slot 210 based on the received synchronization signal. In response to determining the index of the slot 210 and the starting time 201, the terminal device 120 may receive the information in the slot 210 of the determined index starting from the determined time 201.

At block 320, the terminal device 120 determines whether additional reception of the information in the slot 220 is enabled. In response to the additional reception of the information being enabled, at block 330, the terminal device 120 receives the information from the transmitting device 130 in the slot 220 starting from the time 202. The slot 220 may have a same index as the slot 210.

In some embodiments, the terminal device 120 may determine whether the additional reception of the information in the slot 220 is enabled or not based on at least one of the following: a configuration about a carrier on which the terminal device 120 operates, a configuration about a set of resources for receiving the information from the transmitting device 130, a configuration about the additional reception of the information in the slot 220 received by the terminal device 120, and the capability of the terminal device 120. That is, the additional reception of the information in the slot 220 can be enabled or disabled per carrier, per resource set, or per terminal device.

In some embodiments, the information may be transmitted from the transmitting device 130 via at least one of unicast, groupcast, and broadcast. The information transmitted from the transmitting device 130 may include PSCCH and/or PSSCH. In some embodiments, regardless whether the information is to be transmitted via unicast, groupcast or broadcast, the transmitting device 130 may always transmit the information in a slot with a starting time derived from a received synchronization signal. As a result, at the receiving device 120, the timing difference between the reception of the synchronization signal and the reception of the information transmitted from the transmitting device 130 may be longer than the CP length. In this event, the additional reception of the information in the slot 220 may be always enabled for the receiving device 120.

Alternatively, in some embodiments, if the information is transmitted from the transmitting device 130 to the receiving device 120 via unicast or groupcast, the additional reception of the information in the slot 220 may be disabled.

For example, in the case of unicast, prior to the information being transmitted from the transmitting device 130, the receiving device 120 may report an expected timing advance value to the transmitting device 130 in advance, such that the transmitting device 130 can adjust the timing for the transmission of the information based on the timing advance value. In this case, the transmitting device 130 may only transmit the information in one slot based on the adjusted timing. Therefore, the additional reception of the information may be disabled. That is, the receiving device 120 may only receive the information in the first slot, without receiving the information in the second slot.

As another example, in the case of groupcast, prior to the information being transmitted from the transmitting device 130, the receiving device 120 or another receiving device in the groupcast group may report an expected timing advance value to the transmitting device 130 in advance, such that the transmitting device 130 can adjust the timing for the transmission of the information based on the timing advance value. In this case, the additional reception of the information may be disabled. That is, the receiving device 120 may only receive the information in the first slot, without receiving the information in the second slot.

In some embodiments, in response to the additional reception of the information being enabled, the receiving device 120 may determine the timing for the additional reception of the information, such as the time 202 from which the slot 220 starts. In some embodiments, the terminal device 120 may determine the time interval 203 and then determine the time 202 based on the time 201 and the time interval 203. In some embodiments, the time interval 203 may be a predetermined positive value, which can be specified, preconfigured or configured to the terminal device 120.

In some embodiments, for example, the time interval 203 can be specified as a fixed value for a carrier with given subcarrier spacing. In this case, the receiving device 120 may determine the time interval 203 based on subcarrier spacing used at the receiving device 120. In the following, it is assumed that Tc represents the minimum time unit. For example, the time interval 203 can be specified as 3933Tc (that is about 2 μs) or 6547Tc (that is about 3.33 μs) for a carrier with 15 kHz subcarrier spacing. As another example, the time interval 203 can be specified as 4916Tc (that is about 2.5 μs) or 6547Tc (that is about 3.33 μs) for a carrier with 60 kHz subcarrier spacing and with the extended CP configuration.

Alternatively, or in addition, in some embodiments, the time interval 203 may be within a range [2·D/C−L_{cp}, 2·D/C], where D represents a coverage requirement (such as, 1000 meters) associated with the information, C represents a velocity of light, and L_{cp} represents the CP length used at the receiving device 120. That is, in this case, the receiving device 120 may determine the range of the time interval 203 and then select a value from the determined range as the time interval 203.

Alternatively, or in addition, in some embodiments, the time interval 203 may be preconfigured or configured to the terminal device 120 by a network device via radio resource control (RRC) signaling, medium access control (MAC) layer signaling or Physical (PHY) layer signaling. In some embodiments, in response to receiving a configuration about the time interval 203 via RRC signaling, MAC layer signaling or PHY layer signaling, the terminal device 120 may determine the time interval 203 based on the received configuration.

In response to determining the time interval 203, the terminal device 120 can determine, based on the time 201 and the time interval 203, the time 202 from which the slot 220 starts and then perform the additional reception in the slot 220. It can be seen that, by performing both the reception of the information in the slot 210 and the additional reception of the information in the slot 220, the problem caused by the limitation of the CP length can be solved, thereby ensuring the coverage requirement for NR V2X to be satisfied.

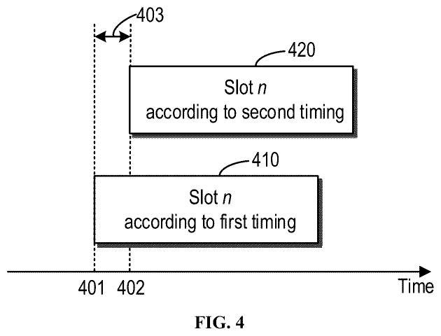

FIG. 4 illustrates a schematic diagram showing an example of sidelink transmission in accordance with some embodiments of the present disclosure.

As shown in FIG. 4, in some embodiments, for sidelink communications, if a transmitting device (for example, the terminal device 130 in FIG. 1) is configured to transmit information (such as, PSCCH and/or PSSCH) to a receiving device (for example, the terminal device 120 in FIG. 1) in a slot 420 starting from a time 402 determined according to second timing, the transmitting device may also need to transmit the information in at least one additional slot 410 starting from a time 401 determined according to first timing. The first timing may be earlier than the second timing by a time interval 403, such that the starting time of any slot with a slot index n determined according to the first timing is earlier than the starting time of the slot with the same slot index n determined according to the second timing by the time interval 403. For example, the time interval 403 may be a threshold time interval which is specified, preconfigured or configured to the transmitting device.

In some embodiments, the slot 420 may be included in a set of resources configured for transmission of the information from the transmitting device 130. For example, the index of the slot 420 and the starting time 402 of the slot 420 may be determined based a synchronization signal received from the synchronization source 110. In some embodiments, the slot 410 starting from the time 401 may be determined based on the slot 420 and the time interval 403. As such, the timing difference (for example, up to 6.66 μs as described above) between the reception of the synchronization signal and the reception of the information can be accommodated, thereby ensuring that the coverage requirement for NR V2X can be satisfied.

In some embodiments, the transmission of the information in the slot 410 (also referred to as “first transmission of the information”) can be enabled or disabled. Alternatively, or in addition, the transmission of the information in the slot 420 (also referred to as “second transmission of the information”) can also be enabled or disabled. For example, in some embodiments, for sidelink communications, both the first and second transmission of the information may be always enabled.

Alternatively, in some embodiments, if the coverage requirement of the information exceeds a threshold range (such as, 700 meters for a carrier with 15 kHz subcarrier spacing, or 625 meters for a carrier with 60 kHz subcarrier spacing and with the extended CP configuration), both the first and second transmission of the information may be enabled. If the coverage requirement of the information is below the threshold range, only the second transmission of the information in the slot 420 may be enabled, while the first transmission of the information in the slot 410 may be disabled.

As another example, in some embodiments, if the information is to be transmitted via unicast or groupcast, the transmitting device may receive expected timing advance values from one or more receiving devices. Alternatively, in some embodiments, if the information is to be transmitted via unicast or groupcast, the transmitting device may determine the timing advance values for one or more receiving devices. In this case, the transmitting device can adjust the transmitting timing for the one or more receiving devices based on the timing advance values. Therefore, only the first transmission of the information in the slot 410 may be enabled, while the second transmission of the information in the slot 420 can be disabled.

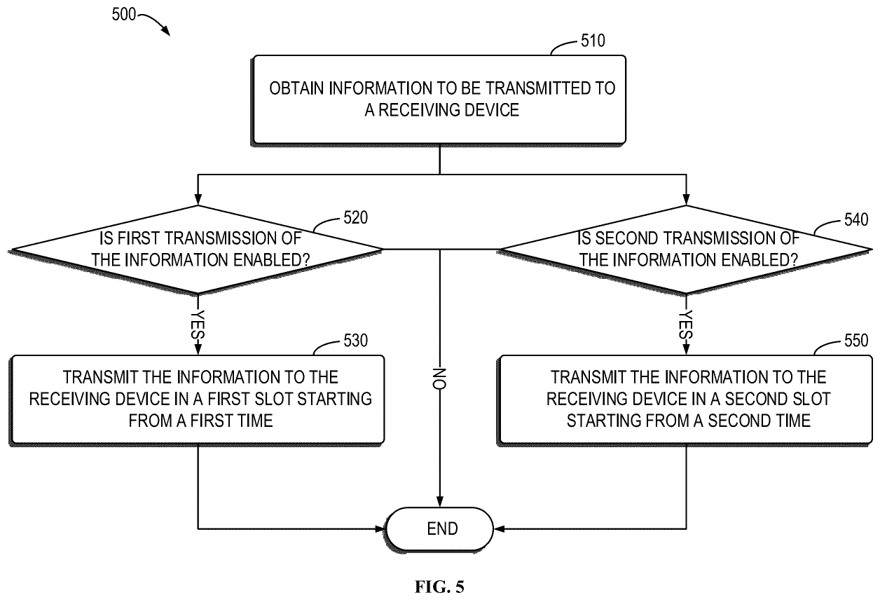

More details about sidelink transmission will be described with reference to FIG. 5, which illustrates an example method 500 of sidelink transmission in accordance with some embodiments of the present disclosure. For example, the method 500 may be performed at a communication device which acts as a transmitting device, such as the terminal device 130. For the purpose of discussion, in the following, the method 500 will be described with reference to FIG. 4. It is to be understood that the method 500 may include additional blocks not shown and/or may omit some blocks as shown, and the scope of the present disclosure is not limited in this regard.

At block 510, the transmitting device 130 obtains information to be transmitted to a receiving device (such as, the terminal device 120). In some embodiments, the information to be transmitted by the transmitting device 130 may include PSCCH and/or PSSCH.

At block 520, the terminal device 130 determines if the first transmission of the information in the slot 410 is enabled or not. In response to the first transmission of the information in the slot 410 being enabled, at block 530, the terminal device 130 transmits the information to the receiving device 120 in the slot 410 starting from the time 401.

At block 540, the terminal device 130 determines if the second transmission of the information in the slot 420 is enabled or not. In response to the second transmission of the information in the slot 420 being enabled, at block 550, the terminal device 130 transmits the information to the receiving device 120 in the slot 420 starting from the time 402, which is later than the time 401 by the time interval 403. The slot 410 may have a same index as the slot 420.

In some embodiments, the terminal device 130 may determine whether the first transmission of the information in the slot 410 and/or the second transmission of the information in the slot 420 are enabled or not based on at least one of the following: a configuration about one or more carriers on which the terminal device 130 operates, a configuration about one or more sets of resources for transmitting the information from the terminal device 130, one or more configurations about the first transmission of the information in the slot 410 and/or the second transmission of the information in the slot 420 received by the terminal device 130, and the capability of the terminal device 130.

In some embodiments, for a given carrier, either the first transmission in the slot 410 or the second transmission in the slot 420 may be configured or pre-configured. That is, if the terminal device 130 is operating on a carrier, it can determine, based on the carrier, whether the first transmission in the slot 410 and/or the second transmission in the slot 420 are enabled or not.

Alternatively, or in addition, in some embodiments, for a given set of resources, either the first transmission in the slot 410 or the second transmission in the slot 420 may be configured or pre-configured. That is, if only one set of resources for the first transmission in the slot 410 are configured to the terminal device 130, the terminal device 130 may determine that the first transmission in the slot 410 is enabled while the second transmission in the slot 420 is disabled. If only one set of resources for the second transmission in the slot 420 are configured to the terminal device 130, the terminal device 130 may determine that the second transmission in the slot 420 is enabled while the first transmission in the slot 410 is disabled. If a first set of resources for the first transmission in the slot 410 and a second set of resources for the second transmission in the slot 420 are configured to the terminal device 130, the terminal device 130 may determine that both the first transmission in the slot 410 and the second transmission in the slot 420 are enabled.

In some embodiments, the information to be transmitted by the transmitting device 130 may be included in a sidelink transmission block (TB). The coverage requirement associated with the TB can be indicated by a higher layer to the physical layer. In some embodiments, in response to the coverage requirement associated with the TB exceeding a threshold range, both the first transmission in the slot 410 and the second transmission in the slot 420 may be enabled. In some embodiments, the threshold range may be specified, preconfigured or configured to the terminal device 130. For example, for a carrier with 15 kHz subcarrier spacing, the threshold range may be 700 meters. As another example, for a carrier with 60 kHz subcarrier spacing and with the extended CP configuration, the threshold range may be 625 meters. In some embodiments, in response to the coverage requirement associated with the TB being below the threshold range, the second transmission in the slot 420 may be enabled, while the first transmission in the slot 410 may be disabled.

In some embodiments, in response to the second transmission of the information in the slot 420 being enabled, the terminal device 130 may determine the timing for the second transmission of the information in the slot 420. In some embodiments, the terminal device 130 may receive a synchronization signal from the synchronization source 110 and determine the timing for transmitting the information in the slot 420 based on the received synchronization signal. For example, the terminal device 130 may determine an index of the slot 420 and the starting time 402 based on the received synchronization signal. In response to determining the index and the starting time 402 of the slot 420, the terminal device 130 may transmit the information in the slot 420 of the determined index starting from the determined time 402.

In some embodiments, in response to the first transmission of the information in the slot 410 being enabled, the terminal device 130 may determine the timing for the first transmission of the information, such as the time 401 from which the slot 410 starts. In some embodiments, the terminal device 130 may determine the time interval 403 and then determine the time 401 based on the time 402 and the time interval 403. In some embodiments, the time interval 403 may be a predetermined positive value, which can be specified, preconfigured or configured to the terminal device 130.

In some embodiments, for example, the time interval 403 can be specified as a fixed value for a carrier with given subcarrier spacing. In this case, the receiving device 130 may determine the time interval 403 based on subcarrier spacing used at the receiving device 130. In the following, it is assumed that Tc represents the minimum time unit. For example, the time interval 403 can be specified as 3933Tc (that is about 2 μs) or 6547Tc (that is about 3.33 μs) for a carrier with 15 kHz subcarrier spacing. As another example, the time interval 403 can be specified as 4916Tc (that is about 2.5 μs) or 6547Tc (that is about 3.33 μs) for a carrier with 60 kHz subcarrier spacing and with the extended CP configuration.

Alternatively, or in addition, in some embodiments, the time interval 403 may be within a range [2·D/C−L_{cp}, 2·D/C], where D represents a coverage requirement (such as, 1000 meters) associated with the information, C represents a velocity of light, and L_{cp} represents the CP length used at the transmitting device 130. That is, in this case, the transmitting device 130 may determine the range of the time interval 403 and then select a value from the determined range as the time interval 403.

Alternatively, or in addition, in some embodiments, the time interval 403 may be preconfigured or configured to the terminal device 130 by a network device via radio resource control (RRC) signaling, medium access control (MAC) layer signaling or Physical (PHY) layer signaling. In some embodiments, in response to receiving a configuration about the time interval 403 via RRC signaling, MAC layer signaling or PHY layer signaling, the terminal device 130 may determine the time interval 203 based on the received configuration.

In some embodiments, the terminal device 130 may be configured with one or more sets of resources. For each of the one or more sets of resources, the terminal device 130 may be further configured to use the set of resources only for the first transmission or only for the second transmission. For example, the slot 410 may be included in a first set of resources configured for the terminal device 130. In response to the first transmission in the slot 410 being enabled, for example, the first set of resources may be used by the terminal device 130 for transmitting the information to the receiving device 120. Alternatively, or in addition, the slot 420 may be included in a second set of resources configured for the terminal device 130.

In response to the second transmission in the slot 420 being enabled, for example, the second set of resources may be used by the terminal device 130 for transmitting the information to the receiving device 120. In some embodiments, the first set of resources may be different from the second set of resources. In some embodiments, for example, the first set of resources may be multiplexed with the second set of resources based on at least one of time division multiplexing (TDM) technology or frequency division multiplexing (FDM) technology. Alternatively, in some embodiments, for example, the first set of resources and the second set of resources may be located on different carriers.

In some embodiments, the information may be transmitted from the transmitting device 130 via at least one of unicast, groupcast and broadcast. The information transmitted from the transmitting device 130 may include PSCCH and/or PSSCH. For example, PSCCH may use the same transmission timing as its associated transmission block.

In some embodiments, regardless whether the information is to be transmitted via unicast, groupcast or broadcast, both the first transmission in the slot 410 and the second transmission in the slot 420 may be enabled. Alternatively, in some embodiments, if the information is to be transmitted via unicast or groupcast, the first transmission in the slot 410 may be enabled, while the second transmission in the slot 420 may be disabled.

In some embodiments, in the case of unicast or groupcast, prior to transmitting the information to a receiving device (such as, the receiving device 120), the transmitting device 130 may determine the time interval 403 based on a predetermined range. For example, the predetermined range may be specified, preconfigured or configured to the terminal device 130. In response to determining the time interval 403, the transmitting device 130 may perform the first transmission in the slot 410 based on the determined time interval 403, without transmitting the information in the slot 420.

In some embodiments, in the case of unicast, prior to transmitting the information to a receiving device (such as, the receiving device 120), the receiving device 120 may transmit assistance information on the time interval 403 to the transmitting device 130 in advance. For example, the assistance information may indicate an expected timing advance value, which corresponds to the time interval 403 to be determined. For example, the timing advance value indicated by the receiving device 120 may be included in a predetermined set of values. The predetermined set of values may be specified, preconfigured or configured to the transmitting device 130. In response to receiving the assistance information, the transmitting device 130 may determine the time interval 403 based on the received assistance information and then perform the first transmission in the slot 410 based on the determined time interval 403, without transmitting the information in the slot 420.

In some embodiments, in the case of groupcast, prior to the information being transmitted from the transmitting device 130, at least one receiving device in the groupcast may transmit assistance information on the time interval 403 to the transmitting device 130 in advance. In some embodiments, the at least one receiving device may include all or part of receiving devices in the groupcast. Alternatively, in some embodiments, the at least one receiving device may be instructed by the transmitting device 130. In response to receiving the assistance information, the transmitting device 130 may determine the time interval 403 based on the received assistance information and then perform the first transmission in the slot 410 based on the determined time interval 403, without transmitting the information in the slot 420.

It can be seen that, by performing the first transmission of the information in the slot 410 and/or the second transmission of the information in the slot 420 according to embodiments of the present disclosure, the problem caused by the limitation of the CP length can be solved, thereby ensuring the coverage requirement for NR V2X to be satisfied.

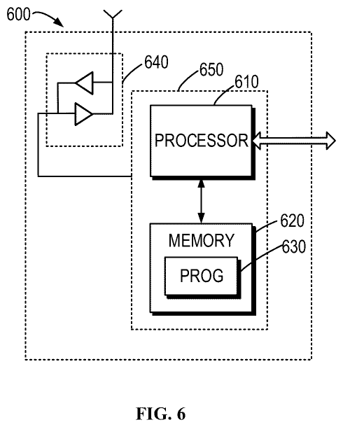

FIG. 6 is a simplified block diagram of a device 600 that is suitable for implementing embodiments of the present disclosure. The device 600 can be considered as a further example implementation of the terminal device 120 or 130 as shown in FIG. 1. Accordingly, the device 600 can be implemented at or as at least a part of the terminal device 120 or 130.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 and 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method performed by a first device, comprising:
receiving a first sidelink signal in a first slot; and
receiving a second sidelink signal, which is same as the first sidelink signal, in a second slot, the second slot being later than the first slot by a time interval.

2. A method performed by a second device, comprising:
transmitting a first sidelink signal in a first slot; and
transmitting a second sidelink signal, which is same as the first sidelink signal, in a second slot, the second slot being later than the first slot by a time interval.

3. A first device, comprising a processor configured to:
receive a first sidelink signal in a first slot; and
receive a second sidelink signal, which is same as the first sidelink signal, in a second slot, the second slot being later than the first slot by a time interval.
